(19) United States
(12) Patent Application Publication
(10) Pub. No.: US 2004/0204069 A1
(43) Pub. Date: Oct. 14, 2004

(54) Method of operating a personal communications system

(76) Inventors: John X. Cui, Bloomingdale, IL (US); Emad S. Isaac, Woodridge, IL (US); Michael Yunil Kim, South Barrington, IL (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/113,428

(22) Filed: Mar. 29, 2002

(51) Int. Cl. H04M 1/00

(52) U.S. Cl. 455/557; 455/418; 455/569.1

(57) ABSTRACT

In a remote communications device (106), a method of operating a personal communications system (102) includes coupling the remote communications device (106) to a vehicle (109), wherein the remote communications device (106) comprises substantially all functionality of the personal communications system and the remote communications device utilizing at least one vehicle resource (116) while coupled to the vehicle. The remote communications device can configure at least one vehicle subsystem (118) while coupled to the vehicle and access content through remote communications device utilizing at the at least one vehicle resource. When remote communications device is uncoupled from the vehicle, it retains the functionality of the personal communications system (102) and remote communications device (106) can access content independent of the vehicle resources.

### BACKGROUND OF THE INVENTION

There is an ever-increasing demand for wireless communication and convenience. Wireless subscribers desire to have access to information at any time and in any place. Wireless subscribers also desire to be able to control other mechanical and electronic devices through one wireless device in an efficient and cost-effective manner. One of the fastest growing markets for providing wireless services is known as “telematics” and entails delivering a wide spectrum of information via wireless links to vehicle-based subscribers. The information can originate from multiple sources, such as the Internet and other public, private, and/or government computer-based networks; wireless telecommunications such as cellular, Personal Communication Service (PCS), satellite, land-mobile, and the like; terrestrial and satellite direct broadcasts including traditional AM/FM bands, broadband, television, video, geolocation and navigation via a global position system (GPS), and the like; concierge services providing roadside assistance, emergency calling, remote-door unlocking, automatic collision notification, travel conditions, vehicle security, stolen vehicle recovery, remote vehicle diagnostics, and the like; advertising services identifying names and locations of businesses such as gas stations, restaurants, hotels, stores, and offices, and the like; tourist services such as points of interest, directions, hours of access, and the like; short range devices such as personal digital assistants (PDA's), and many other sources that can provide information of any type.

Information can be communicated to telematics devices over relatively long wireless links, such as from a satellite or terrestrial node, or from relatively short wireless or wired links, such as from in-vehicle equipment or from hand-held devices like PDAs, portable computers, cellular phones, and the like.

In prior art systems, subscribers often have two separate wireless devices and two separate wireless accounts and/or two different phone numbers/access codes, one for telematics and one for their personal wireless devices. Most telematics features are integrated into a fixed telematics unit within a vehicle. The wireless devices that link to the telematics system are generally short-range and provide limited functionality. The personal wireless devices are often incompatible with the telematics device and limit access to the telematics device and vehicle systems. The subscriber must have at least two different wireless devices, a Telematics device fixed in a vehicle and a PDA or cellular phone that are incompatible or fail to interoperate effectively. Another drawback of the prior art is that a subscriber's personal wireless device does not interoperate with a vehicle's security features such as door-locking, alarm system, car-jacking prevention, automatic collision notification system, and the like. Today's wireless subscriber desires that the vast array of features available in one device that interfaces with and utilizes vehicle resources and subsystems efficiently.

Accordingly, there is a significant need for a method for an integrated personal communications system that overcomes the deficiencies of the prior art outlined above.

### BRIEF DESCRIPTION OF THE DRAWINGS

Referring to the drawing:

FIG. 1 depicts a communications system according to one embodiment of the invention;

FIG. 2 depicts hardware modules of a remote communications device according to one embodiment of the invention;

FIG. 3 depicts software modules of a remote communications device according to another embodiment of the invention; and

FIG. 4 illustrates a flow diagram of a method of the invention according an embodiment of the invention;

It will be appreciated that for simplicity and clarity of illustration, elements shown in the drawing have not necessarily been drawn to scale. For example, the dimensions of some of the elements are exaggerated relative to each other. Further, where considered appropriate, reference numerals have been repeated among the Figures to indicate corresponding elements.

### DESCRIPTION OF THE PREFERRED EMBODIMENTS

In the following detailed description of exemplary embodiments of the invention, reference is made to the accompanying drawings, which of illustrate specific exemplary embodiments in which the invention may be practiced. These embodiments are described in sufficient detail to enable those skilled in the art to practice the invention, but other embodiments may be utilized and logical, mechanical, electrical and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact. However, “coupled” may also mean that two or more elements are not in direct contact with each other, but yet still co-operate or interact with each other.

For clarity of explanation, the illustrate embodiments of the present invention is presented, in part, as comprising individual functional blocks. The functions represented by these blocks may be provided through the use of either shared or dedicated hardware, including, but not limited to, hardware capable of executing software. The present invention is not limited to implementation by any particular set of elements, and the description herein is merely representational of one embodiment.

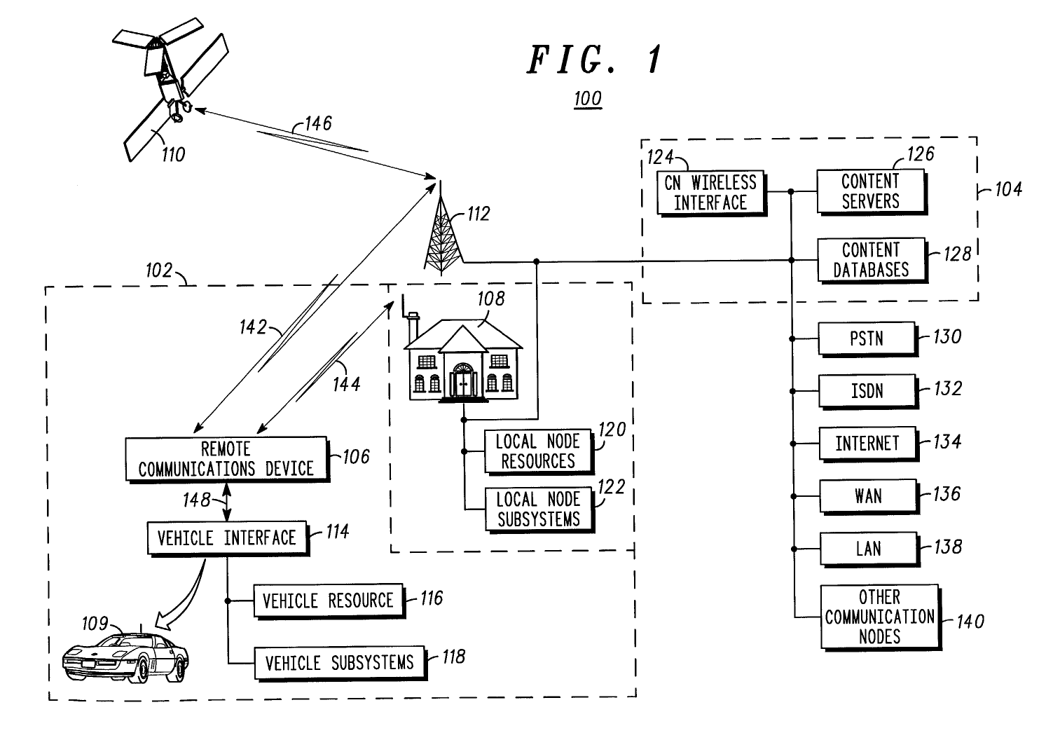

FIG. 1 depicts a communications system 100 according to one embodiment of the invention. As shown in FIG. 1, communications system 100 includes communications node 104 and personal communications system 102. Personal communications system 102 can include remote communications device 106, vehicle 109 with vehicle interface 114 and, optionally, local communications node 108. Vehicle 109 can include, without limitation, a car, truck, bus, train, aircraft, boat, and the like. Although only one remote communications device 106, vehicle 109 and local communications node 108 are shown as comprising personal communications system 102, the invention can include any number of these elements interoperating with each other.

Remote communications device 106 can include, without limitation, a wireless unit such as a portable Telematics device, cellular or Personal Communication System (PCS) telephone, a pager, a hand-held computing device such as a personal digital assistant (PDA) or Web appliance, a personal computer, or any other type of wireless or wireline communications and/or computing device. Remote communications device 106 comprises substantially all of the functionality of personal communications system 102. Substantially all of the functionality includes, but is not limited to, functional and operative hardware and software modules, input/output (I/O) elements, display, telematics system applications, and the like. Remote communications device 106 having substantially all of the functionality of the personal communications system 102 can operate and access content independently of vehicle 109 and vehicle resources 116.

Remote communications device 106 can be coupled to vehicle 109 via vehicle interface 114, which can be, without limitation, a wireless or wireline interface. If coupled, remote communications device 106 and vehicle 109 can communicate via communications link 148, which can be a wireless or wireline communications link. Vehicle interface 114 allows remote communications device 106 to communicate with, exchange data with and utilize one or more vehicle resources 116 and one or more vehicle subsystems 118. Communicating with can include, without limitation, accessing, operating, configuring, controlling, streaming media to and from, voice communication, downloading or uploading software, communicating status, and the like. Vehicle resource 116 can include, for example and without limitation, vehicle power system, antenna(s), memory, and the like. Vehicle subsystem 118 can include, for example and without limitation, ignition system, door-locking system, comfort features such as seat and mirror adjustments, climate control, automatic distress system, security system, positioning system(s), and the like. Vehicle interface 114 also allows remote communications device 106 to access the status of any of vehicle resources 116 and vehicle subsystems 118, for example, security status, engine status, internal climate status, occupancy detection system, car start detection system, change in vehicle position (delta-GPS) system, and the like. In one embodiment, vehicle interface 114 allow telematics device to exchange data with including access, operate, control and configure any of the vehicle subsystems 118.

Communications system 100 can include communications node 104, which can be coupled to any number of local communications nodes 108 and base stations 112 to provide wireless communication to and from remote communications device 106 via wireless communications links 142 or 144. Communications node 104 can be coupled to base station 112 and local communications node 108 via wireline or wireless communication links (not shown). Communications node 104 also can communicate with satellite 110 via communications link 146. Communications node 104 is shown communicating with satellite 110 via base station 112 however, communications node 104 is also capable of communicating directly with satellite 110.

Communications node 104 can include content servers 126 and content databases 128, which can include a hard drive, floppy disk drive, optical drive, CD-ROM, RAM, ROM, EEPROM, or any other means of storing content, which can be utilized by remote communications device 106. In the embodiment depicted in FIG. 1, content databases 128 function to store location information, user profiles, traffic content, map content, point-of-interest content, usage history, and the like. However content databases 128 are not limited to these functions, and other database functions are within the scope of the invention.

Communications node 104 can also include a communications node (CN) wireless interface 124, which can comprise one or more network access devices (NAD's) that can utilize a wireless network protocol that can include, without limitation, narrowband and/or broadband connections with standard cellular network protocols such as Global System for Mobile Communications (GSM), Time Division Multiple Access (TDMA), Code Division Multiple Access (CDMA), and the like. In another embodiment, standard transmission control protocol/internet protocol (TCP/IP) can also be used. CN wireless interface 124 can also send and receive content using standard paging networks, FM sub-carriers, satellite networks, and the like. Communications node 104 can be coupled to a public switched telecommunication network (PSTN) 130, an integrated services digital network (ISDN) 132, Internet 134, one or more wide area networks (WAN's), one or more local area networks (LAN's) 138, and any number of other communications nodes 140.

Local communications node 108 can optionally form a portion of personal communications system 102, and can take the form of a kiosk, or any wireless or wireline communications platform capable of interfacing through wireless or wireline means with remote communications device 106. For example, local communications node 108 can be a wireless communication platform kiosk located in a public building, business, home, and the like. Local communications node 108 can include local communications node resources 120 and local communications node subsystems 122, which are analogous to vehicle resources 116 and vehicle subsystems 118 respectively.

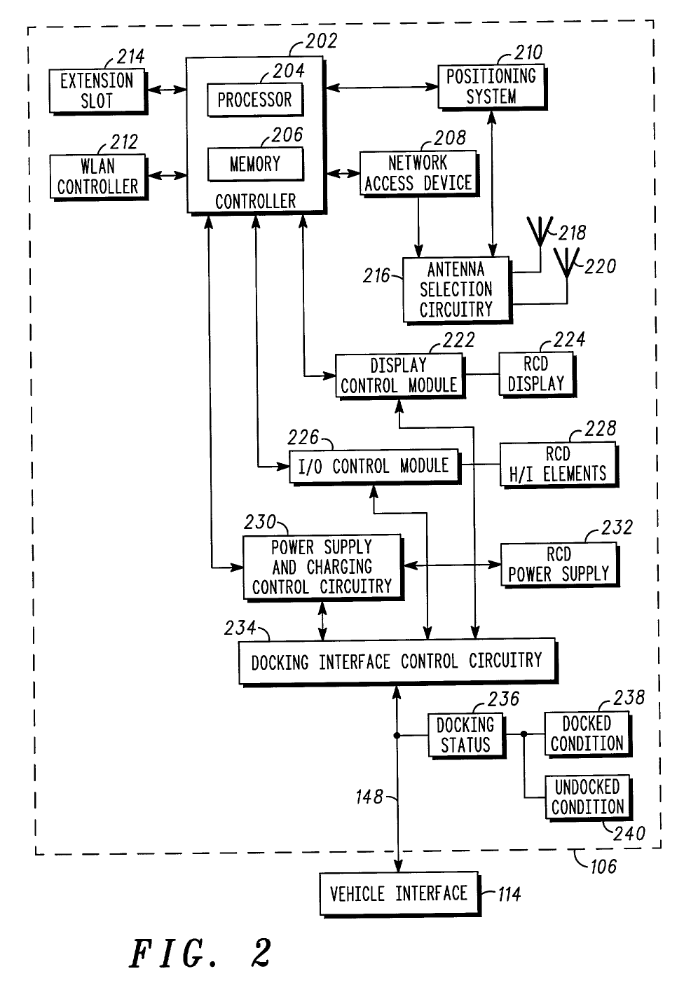

FIG. 2 depicts hardware modules of a remote communications device 106 according to one embodiment of the invention. As shown in FIG. 2, the core module of remote communications device 106 is the controller 202, which controls I/O signals, communication interfaces, displays, and the like, according to the docking status 236 of remote communications device 106 with vehicle 109. When remote communications device 106 is coupled to vehicle 109 via vehicle interface 114, a docked condition 238 is indicated and remote communications device 106 functions a communications platform integrated with in-vehicle telematics peripherals and other vehicle resources 116 and vehicle subsystems 118. For example, and without limitation, in the docked condition 238, remote communications device 106 can use vehicle resources 116 such as vehicle power systems, antennas, displays, audio systems, interfaces, and the like. When remote communications device 106 is uncoupled from vehicle 109, remote communications device 106 becomes a stand-alone telematics and personal communications system using its own power, display, interfaces, antennas, and the like. The individual hardware modules are described in more detail below.

Controller 202 functions to activate telematics system applications, positioning system 210, other personal information management services, and the like. Controller 202 is coupled to network access device (NAD) 208 and monitors input signals, controls display output and communicates with other wireless devices in a local area network (LAN). Substantially all controller functions operate according to docking status 236 of either a docked condition 238 or an undocked condition 240 with vehicle 109. Controller comprises at least one processor 204 for processing algorithms stored in memory 206. Memory 206 comprises control algorithms, and can include, but is not limited to, random access memory (RAM), read only memory (ROM), flash memory, electrically erasable programmable ROM (EEPROM), and the like. Memory 206 can contain stored instructions, tables, data, and the like, to be utilized by processor 204. Memory 206 can also can be used to store information pertaining to personal communications system 102, for example, user profiles, usage history, preferences, and the like.

Positioning system 210 is coupled to controller 202 and can include any number of position sources, devices and software elements designed to determine a position of remote communications device 106 and associated vehicle 109 when in a docked condition 238. Examples of sources and devices, without limitation, include global positioning system (GPS), differential GPS, a kiosk (fixed position source), and enhanced observed time difference (EOTD), which comprise terrestrial cellular triangulation, and the like. Other navigational position sources and software can include, without limitation, an airspeed device, Doppler device, inclinometer, accelerometer, speedometer, compass, gyroscope altimeter, network-assisted GPS, differential GPS, any combination of optical transmitters, receivers, reflectors, optically readable tag, gyro, and the like.

NAD 208 is coupled to controller 202 and controls connection to wireless communication networks, other than LAN's and can utilize wireless network protocols described in conjunction with CN wireless interface 124 above. Antenna selection circuitry 216 controls selection between internal remote communications device antennas 218, 220 and vehicle antennas based on docking status 236. When remote communications device 106 is in the undocked condition 240, internal antennas 218, 220 are used for wireless communication including content and positioning data for positioning system 210.

Display control module 222 is coupled to controller 202 and docking interface control circuitry 234 and controls the display destination of remote communications device 106 based on docking status 236. For example, in a docked condition, display control module 222 can route display functions to an in-vehicle display. In an undocked condition 240 display functions can be routed to remote communication device (RCD) display 224. In another embodiment, RCD display 224 can also include touch-screen control buttons, in which case display control module 222 and I/O control module 226 functions can merge.

I/O control module 226 is coupled to controller 202 and docking interface control circuitry 234 and couples remote communications device 106 to in-vehicle resources and subsystems when in a docked condition 238, particularly in-vehicle human interface (H/I) elements. When in an undocked condition 240, I/O control module switches so that RCD H/I elements 228 are active. H/I elements, whether in-vehicle or on remote communications device 106 can comprise elements such as a multi-position controller, one or more control knobs, one or more indicators such as bulbs or light emitting diodes (LEDs), one or more control buttons, one or more speakers, a microphone, and any other H/I elements required by wireless device. RCD H/I elements 228 can request and display content and data including, application data, position data, personal data, email, audio/video, and the like. The invention is not limited by the (H/I) elements described above. As those skilled in the art will appreciate, the (H/I) elements outlined above are meant to be representative and to not reflect all possible (H/I) elements that may be employed.

Power supply and charging control circuitry 230 is coupled to controller 202 and docking interface control circuitry 234. This module functions to switch between RCD power supply 232 in an undocked condition 240 and vehicle resources 116 such as in-vehicle power supply in a docked condition 238. RCD power supply 232 can comprise a rechargeable battery or other convenient, portable power source. Power supply and charging control circuitry 230 also allows RCD power supply 232 to recharge using in-vehicle power, local communications node 108 power, and the like.

Local wireless area network (WLAN) controller 212 is coupled to controller 202 and operates to interface remote communications device 106 with WLAN devices using a peer-to-peer environment or a piconet environment. WLAN controller can use “over the air” transport protocols, telephony control protocols, adopted protocols, core protocols, cable replacement protocols, and the like. WLAN controller can interface with any number of WLAN systems, each with their own software protocols and protocol stacks. Examples of these WLAN systems include, but are not limited to, Bluetooth, Infrared Data Association (IrDA), HomeRF, 802.11, Wireless Application Protocol (WAP), Dedicated Short Range Communication (DSRC) system, other broadband systems, and the like.

Extension slot 214 is coupled to controller 202 and makes remote communications device 106 extendable by providing a standard interface to synchronize with other electronic devices, to connect to test/diagnosis devices, and the like.

Docking interface control circuitry 234 provides remote communications device 106 with an interface to vehicle 109 including vehicle resources 116 and vehicle subsystems 118. Through docking interface control circuitry 234, remote communications device 106 can become the communication platform of a vehicle telematics system by coupling remote communications device 106 with vehicle resources 116 such as power systems, antennas, and the like, and vehicle subsystems 118 such as displays, H/I elements, voice recognition, and the like.

The hardware modules shown in FIG. 2 are exemplary and not limiting of the invention. Other hardware modules can also be included in remote communications device 106 and are also within the scope of the invention.

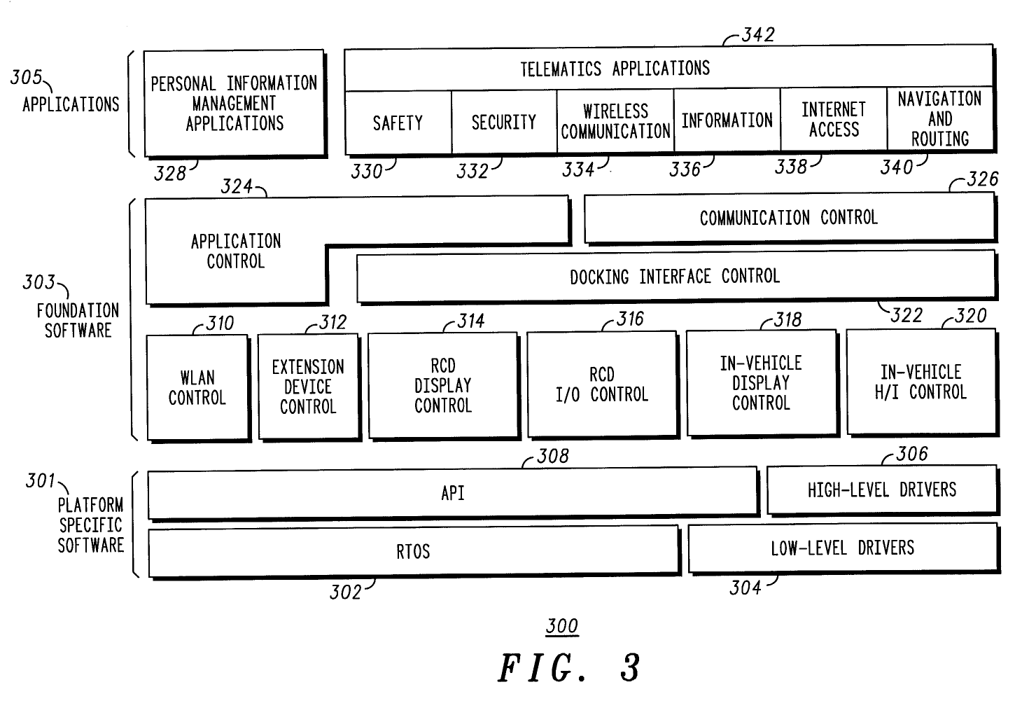

FIG. 3 depicts software modules 300 of a remote communications device 106 according to another embodiment of the invention. As shown in FIG. 3, major functional software blocks of remote communications device 106 in accordance with one embodiment of the invention are shown. Architecturally, remote communications device 106 comprises a software-based client platform that supports a wide range of applications and services. This provides great flexibility and allows the user platform's feature set to be readily expanded or updated after the remote communications device 106 has been deployed into its intended market.

These software blocks are computer program modules comprising computer instructions that are stored in a computer-readable medium such as memory 206. These software modules are merely representative of one embodiment of the invention. In other embodiments, additional modules could be provided as needed, and/or unneeded modules could be deleted.

The software blocks include the following modules, each of which is briefly summarized below according to its reference numeral in FIG. 3. The client platform software comprises three general layers: applications 305, foundation software 303 upon which the applications 305 are supported, and platform-specific software 301. In one embodiment, the upper two layers are implemented in the Java™ programming language, available from various suppliers, including Sun Microsystems, Inc., Palo Alto, Calif. One advantage of the Java™ programming language is the support of code distribution in a platform-independent manner.

The lowest layer, i.e. the platform-specific software 301, comprises a real-time operating system (RTOS) 302, a virtual machine platform (such as the Java™ 2 Virtual Machine, available from Sun Microsystems, Inc.). The application program interface (API) 308 is used for the RTOS 302 and other functions such as for communication with WLAN devices, and the like. Low level drivers 304 function to control devices directly related to processor 204 such as I/O ports, timer control units, memory 206, and the like. High level drivers 306 function to control peripherals such as RCD display 224, NAD 208, WLAN controller 212, and the like.

Applications 305 can comprise an extremely wide variety of informational, safety, query, communications, entertainment, and other applications, for example personal information management applications 328 and telematics applications such as safety 330, security 332, wireless communication 334, information 336, internet access 338, navigation and dynamic routing guidance 340, and others applications of any type. As used herein, an “application” is defined as any computer program that provides one or more functions that are of interest to a user of remote communications device 106.

Applications can provide access to services, which can be offered to users of personal communications system 102 via remote communications device 106. Services can be located at remote communications device 106, communications node 104, distributed between remote communications device 106, communications node 104, and other communications systems, and the like. A service can be an encapsulation of some functionality that is of use to one or more applications (current or anticipated) or that needs to be isolated from the application for some reason. Services also provide a desired functionality of a human user, such as an on-board global positioning system (GPS) device, games, email, and the like.

Telematics applications 342 provide telematics related services such as emergency assistance, stolen vehicle tracking, anti-threat notification, roadside assistance, Internet access, email, telephony, navigation, and the like. Telematics applications 342 are independent from other software modules to allow easy updating for personal customization.

Personal information management applications 328 include add-on features to a standard telematics system. They provide common functions of a PDA such as address book functions, personal scheduling, and the like. Also provided are functions to synchronize these features with other PDA's and electronic devices through either the extension slot 214 or WLAN controller 212.

Foundation software 303 includes software modules to isolate applications from the docking status 236 of remote communications device 106. These include, for example, WLAN control 310, extension device control 312, RCD display control 314, RCD I/O control 316, and RCD H/I control 320. RCD display control 314 and RCD I/O control 316 are used when remote communications device 106 operates in an undocked condition 240 in order to provide capability to RCD display 224 and RCD H/I elements 228. In-vehicle display control 318 and in-vehicle H/I control 320 are used when remote communications device 106 operates in a docked condition 238 in order to communicate with vehicle resources 116 and vehicle subsystems 118 such as displays, H/I elements, and the like. Docking interface control module 322 monitors the docking status 236 to switch display and H/I elements between in-vehicle and those of remote communications device 106. WLAN control 310 controls communication between remote communications device 106 and WLAN devices. Extension device control 312 contains software to connect remote communications device 106 to an external device.

Application control module 324 controls the operation and status of remote communications device 106, activates telematics applications 342 and personal information and management applications 328, manages required resources for applications and monitors errors during operation. Communication control module 326 manages communication devices to provide successful connection to vehicle resources 116 and vehicle subsystems 118. These two modules operate independent of docking status 236.

Substantially all of the functionality of the personal communications system 102 resides with remote communications device 106. This can include, for example and without limitation, at least one telematics application, at least one of the exemplary hardware modules as shown in FIG. 2, or at least one of the exemplary software modules in applications 305 as shown in FIG. 3. Remote communications device 106 can operate as a stand-alone communications platform while utilizing resources from either a vehicle 109 local communications node 108 to augment features such as applications, power, memory, range and to access additional services for use by applications 305.

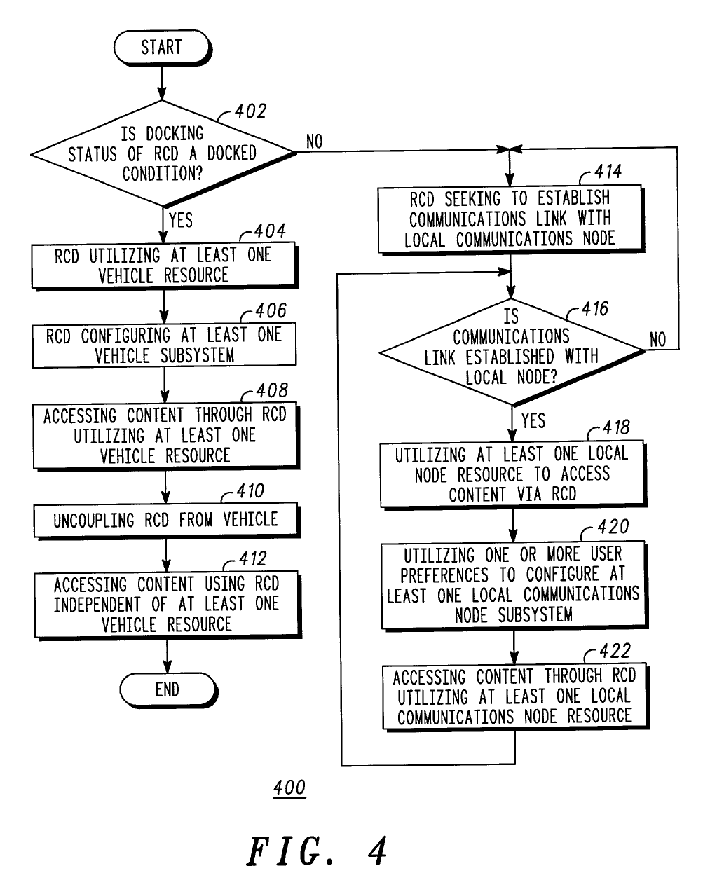

FIG. 4 illustrates a flow diagram 400 of a method of the invention according an embodiment of the invention. In step 402, it is determined if the docking status 236 of remote communications device 106 is a docked condition 238. In other words, it is determined if remote communications device 106 is coupled with vehicle 109 via vehicle interface 114. If there is a docked condition 238, remote communications device utilizes at least one vehicle resource 116 per step 404, which can include, for example and without limitation, in-vehicle power source, in-vehicle antenna, and the like.

In step 406, remote communications device 106 configures at least one vehicle subsystem 118. Remote communications device 106, can exchange data with including access, control, configure, operate and check the status of vehicle resources 116 and vehicle subsystems 118. In another embodiment, remote communications device 106 can be used to exchange data with including access, control, configure, operate, and check the status of, vehicle resources 116 and vehicle subsystems 118 in at least one vehicle 109. In other words, remote communications device 106 can exchange data with including access, control, configure, operate, and the like, vehicle resources 116 and vehicle subsystems 118 in more than one vehicle 109.

Vehicle subsystems can be configured utilizing user preferences of remote communications device 106. A user of remote communications device 106 can create a user profile using remote communications device 106 or any other electronic device that can access communications system 100 or personal communications system 102, for example, a personal computer and a web browser, and the like. A user profile can be used to configure, personalize or preset vehicle subsystems 118. In yet another embodiment, a user of remote communications device 106 can register one or more remote communications devices 106. The user profile can contain registration information and preference information for the remote communications device 106, vehicle subsystems 118, and the like. In another embodiment, remote communications device 106 can be used instead of keys or other conventional access methods currently used to access vehicle 109. User profile registered with personal communications system 102 can also control which remote communications devices 106 are permitted to access vehicle 109, vehicle resources 116, vehicle subsystems 118 and the like.

In step 408, content is accessed through remote communications device 106 utilizing at least one vehicle resource 116. Content can include, without limitation, voice data, video data, text data, emails, software, streaming audio and video, positioning data, and the like. In an embodiment of the invention, while remote communications device 106 is coupled to vehicle in a docked condition 238, content is accessed utilizing at least one vehicle resource 116, for example, in-vehicle power, in-vehicle antennas, in-vehicle memory, and the like. This has the advantage of allowing remote communications device 106 to utilize more extensive resources that it might otherwise have available in an undocked condition 240.

Remote communications device 106 is uncoupled from vehicle 109 in step 410, leaving remote communications device 106 in an undocked condition. Remote communications device 106 then can access content independent of at least one vehicle resource 116. In other words, remote communications device 106 can access content as a stand-alone communications platform while carrying substantially all of the functionality of personal communications system 102 with it in the form of hardware modules and applications.

If docking status 236 of remote communications device 106 not a docked condition in step 402, i.e. and undocked condition 240, remote communications device 106 seeks to establish a communications link 144 with local communications node 108 per step 414. When in an undocked condition 240 remote communications device 106 seeks to establish a communications link 144 with a local communications node 108 to enhance the available resources and functionality of remote communications node. This can include, for example, access to additional services, applications, power, additional communication systems like LAN's or WAN's, and the like. Although communication link 144 is shown as a wireless communication link in FIG. 1, communications link 144 can be a wireline communication link as well. For example, remote communications device 106 can be docked with local communications node 108 in a manner similar to docking with vehicle interface 114.

In step 416, it is determined if communications link 144 is established between local communications node 108 and remote communications device 106. If not, remote communications device 106 continues to seek as illustrated by the return arrow from step 416 to step 414. If a communications link 144 is established per step 416, then remote communications device 106 utilizes at least one local node resource 120 to access content. Local communications node resources 120 can be analogous to vehicle resources 116. In step 420, one or more user preferences can be utilized to configure at least one local communications node subsystem 122. Local communications node subsystems 122 can include items analogous to vehicle subsystems 118, for example, displays, control buttons, and the like.

In step 422, content is accessed through remote communications device 106 utilizing at least one local communications node resource 120. Local communications node resources 120 can include resources analogous to vehicle resources 116, for example, power, antennas, and the like. When communications link 144 is disconnected, remote communications device 106 can continue to access content as a stand-alone communications platform and also continue seeking to establish communications link 144 with local communications node 108 per the return arrow from step 422.

While we have shown and described specific embodiments of the present invention, further modifications and improvements will occur to those skilled in the art. It is therefore, to be understood that appended claims are intended to cover all such modifications and changes as fall within the true spirit and scope of the invention.

1. In a remote communications device, a method of operating a personal communications system, comprising:
coupling the remote communications device to a vehicle, wherein the remote communications device comprises substantially all functionality of the personal communications system;
the remote communications device utilizing at least one vehicle resource while coupled to the vehicle;
the remote communications device configuring at least one vehicle subsystem while coupled to the vehicle;
accessing content through remote communications device utilizing at the at least one vehicle resource;
uncoupling remote communications device from the vehicle, wherein the remote communications device retains the functionality of the personal communications system; and
accessing content using the remote communications device independent of the at least one vehicle resource.

2. The method of claim 1, wherein one or more user preferences reside with the remote communications device, and wherein configuring the at least one vehicle subsystem comprises personalizing the at least one vehicle subsystem according to the one or more user preferences.

3. The method of claim 1, further comprising the remote communications device seeking to establish a communications link with a local communications node.

4. The method of claim 3, further comprising the remote communications device establishing the communications link with the local communications node, wherein at least one local node resource is utilized to access content via the remote communications device.

5. The method of claim 4, further comprising utilizing one or more user preferences residing with the remote communications device to configure at least one local communications node subsystem.

6. The method of claim 1, wherein substantially all of the functionality of the personal communications system resides with the remote communications device.

7. The method of claim 1, wherein substantially all of the functionality of the personal communications system comprises at least one telematics application.

8. The method of claim 1, wherein substantially all of the functionality of the personal communications system comprises at least one hardware module.

9. The method of claim 1, wherein substantially all of the functionality of the personal communications system comprises at least one software module.

10. The method of claim 1, wherein the remote communications device is a portable Telematics device.

11. In a remote communications device, a method of operating a personal communications system, comprising:
the remote communications device determining a docking status, wherein the docking status comprises one of a docked condition and an undocked condition between the remote communications device and a vehicle, wherein at least one telematics application reside with the remote communications device, and wherein the at least one telematics application can function independent of the docking status;
if the docking status indicates the docked condition the remote communications device accessing content utilizing at least one vehicle resource, and wherein the at least one telematics application utilize at least one vehicle subsystem in accessing content; and
if the docking status indicates the undocked condition the remote communications device accessing content independent of the at least one vehicle resource.

12. The method of claim 11, wherein one or more user preferences reside with the remote communications device, and wherein configuring the at least one vehicle subsystem comprises personalizing the at least one vehicle subsystem according to the one or more user preferences.

13. The method of claim 11, further comprising the remote communications device seeking to establish a communications link with a local communications node.

14. The method of claim 13, further comprising the remote communications device establishing the communications link with the local communications node, wherein at least one local node resource is utilized to access content via the remote communications device.

15. The method of claim 14, further comprising utilizing one or more user preferences residing with the remote communications device to configure at least one local communications node subsystem.

16. A computer-readable medium containing computer instructions for instructing a processor to perform in a remote communications device, a method of operating a personal communications system, the instructions comprising:
coupling the remote communications device to a vehicle, wherein the remote communications device comprises substantially all functionality of the personal communications system;
the remote communications device utilizing at least one vehicle resource while coupled to the vehicle;
the remote communications device configuring at least one vehicle subsystem while coupled to the vehicle;
accessing content through remote communications device utilizing at the at least one vehicle resource;
uncoupling remote communications device from the vehicle, wherein the remote communications device retains the functionality of the personal communications system; and
accessing content using the remote communications device independent of the at least one vehicle resource.

17. The computer-readable medium of claim 16, wherein one or more user preferences reside with the remote communications device, and wherein configuring the at least one vehicle subsystem comprises personalizing the at least one vehicle subsystem according to the one or more user preferences.

18. The computer-readable medium of claim 16, further comprising the remote communications device seeking to establish a communications link with a local communications node.

19. The computer-readable medium of claim 18, further comprising the remote communications device establishing the communications link with the local communications node, wherein at least one local node resource is utilized to access content via the remote communications device.

20. The computer-readable medium of claim 19, further comprising utilizing one or more user preferences residing with the remote communications device to configure at least one local communications node subsystem.

21. The computer-readable medium of claim 16, wherein substantially all of the functionality of the personal communications system resides with the remote communications device.

22. The computer-readable medium of claim 16, wherein substantially all of the functionality of the personal communications system comprises at least one telematics application.

23. The computer-readable medium of claim 16, wherein substantially all of the functionality of the personal communications system comprises at least one hardware module.

24. The computer-readable medium of claim 16, wherein substantially all of the functionality of the personal communications system comprises at least one software module.
